(19) United States
(12) Patent Application Publication
(10) Pub. No.: US 2009/0079404 A1
(43) Pub. Date: Mar. 26, 2009

(54) SINGLE-INDUCTOR MULTIPLE-OUTPUT DC/DC CONVERTER METHOD

(75) Inventor: John M. Pigott, Phoenix, AZ (US)

Correspondence Address: INGRASSIA FISHER & LORENZ, P.C. (FS), 7010 E. COCHISE ROAD, SCOTTSDALE, AZ, 85253, US

(73) Assignee: FREESCALE SEMICONDUCTOR, INC., Austin, TX (US)

(21) Appl. No.: 11/859,602

(22) Filed: Sep. 21, 2007

(51) Int. Cl. G05F 1/44; G05F 1/00

(52) U.S. Cl. 323/271

(57) ABSTRACT

A method of configuring a DC/DC converter having a plurality of outputs for providing a regulated voltage to each output electrically coupled to an error amplifier of a plurality of error amplifiers and an inductor includes configuring a plurality of controllable switches coupled to the plurality of error amplifiers to operate using a plurality of duty cycles according to D_{N}=E_{N}/ΣEᵢ, where D_{N} is a duty cycle for an Nth switch of the plurality of controllable switches, E_{N} is an Nth error amplifier signal of a plurality of error amplifier signals, and ΣEᵢ is a total error signal generated by summing the plurality of error amplifier signals.

### FIELD OF THE INVENTION

The present invention relates generally to Direct Current to Direct Current (DC/DC) converters, and more particularly to a method of achieving multiple outputs in such converters using a single inductor.

### BACKGROUND OF THE INVENTION

A Direct Current to Direct Current (DC/DC) converter is a circuit which converts a source of direct current from one voltage to another. DC/DC converters are important in portable electronic devices such as cellular phones and laptop computers, which are supplied with power from batteries. Such electronic devices often contain several sub-circuits with each sub-circuit requiring a unique voltage level different than that supplied by the battery (sometimes higher or lower than the battery voltage, and possibly even negative voltage).

Additionally, the battery voltage declines as its stored power is drained. DC/DC converters offer a method of generating multiple controlled voltages from a single variable battery voltage, thereby saving space instead of using multiple batteries to supply different parts of the device. Existing DC/DC converters typically use a single inductor or winding per output supply.

### BRIEF DESCRIPTION OF THE DRAWINGS

The present invention will hereinafter be described in conjunction with the following drawing figures, wherein like numerals denote like elements, and wherein

FIG. 1 is a simplified block diagram of an exemplary embodiment of a single inductor, multiple output DC/DC converter;

FIG. 2 is a schematic diagram of an exemplary embodiment of a portion of the converter depicted in FIG. 1;

FIG. 3 is a simplified block diagram of an exemplary embodiment of the controller depicted in FIG. 1; and

FIG. 4 is an exemplary method of configuring and operating the DC/DC converter depicted in FIG. 1.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, or the following detailed description.

For simplicity and clarity of illustration, the drawing figures illustrate the general manner of construction, and descriptions and details of well-known features and techniques may be omitted to avoid unnecessarily obscuring the invention. Additionally, elements in the drawings figures are not necessarily drawn to scale. For example, the dimensions of some of the elements or regions in the figures may be exaggerated relative to other elements or regions to help improve understanding of embodiments of the invention.

The terms “first,” “second,” “third,” “fourth” and the like in the description and the claims, if any, may be used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have” and any variations thereof, are intended to cover non-exclusive inclusions, such that a process, method, article, or apparatus that comprises a list of elements is not necessarily limited to those elements, but may include other elements not expressly listed or inherent to such process, method, article, or apparatus. The term “coupled,” as used herein, is defined as directly or indirectly connected in an electrical or non-electrical manner.

In light of the foregoing, it is desirable to implement a DC/DC converter with accompanying control architecture which allows multiple independent outputs to be efficiently and precisely regulated from a DC/DC converter using a single inductance. The claimed subject matter provides for a continuous mode DC/DC converter with a single inductor, and a method of configuring such a converter. Using the following claimed configuration, any number of independent outputs may be controlled.

As will be further described in additional detail, a converter may be configured with a single inductor coupled between an input stage (having an input switch) and a varying number of switches. Each of the varying number of switches is then coupled to respective output voltages. A controller is coupled to the input switch of the input stage to regulate an input current to the inductor. The controller is coupled to each of the output voltages via an error amplifier.

In one embodiment, the respective output signals of each error amplifier may be summed to represent a total output error. The total output current may be calculated and/or registered by the controller. The value of the total output error may then be used to set the value of the coil current (e.g., inductor current). Accordingly, the input switch may be operated by the controller to provide sufficient input current to generate a requisite average inductor current.

In one embodiment, the controller may set a duty cycle for each of the controllable switches in the converter using the total error signal and the value of a respective error signal of a particular output stage according to D_{N}=E_{N}/ΣEᵢ, where D_{N} is the duty cycle for an Nth switch of the number of controllable switches, E_{N} is an Nth output error of the number of output error signals, and ΣEᵢ is the sum of error signals of the converter. The controller sets the various duty cycles such that the sum of the duty cycles remains equal to one.

The converter need not change from one regulator duty cycle to another at a multiple of the coil switching frequency (i.e., the frequency of the input switch). For example, in a three coil converter, the respective duty % changes three times per cycle of the input switch. In addition, the order that each regulator duty cycle is performed may be reordered to improve the overall performance and/or efficiency of the converter.

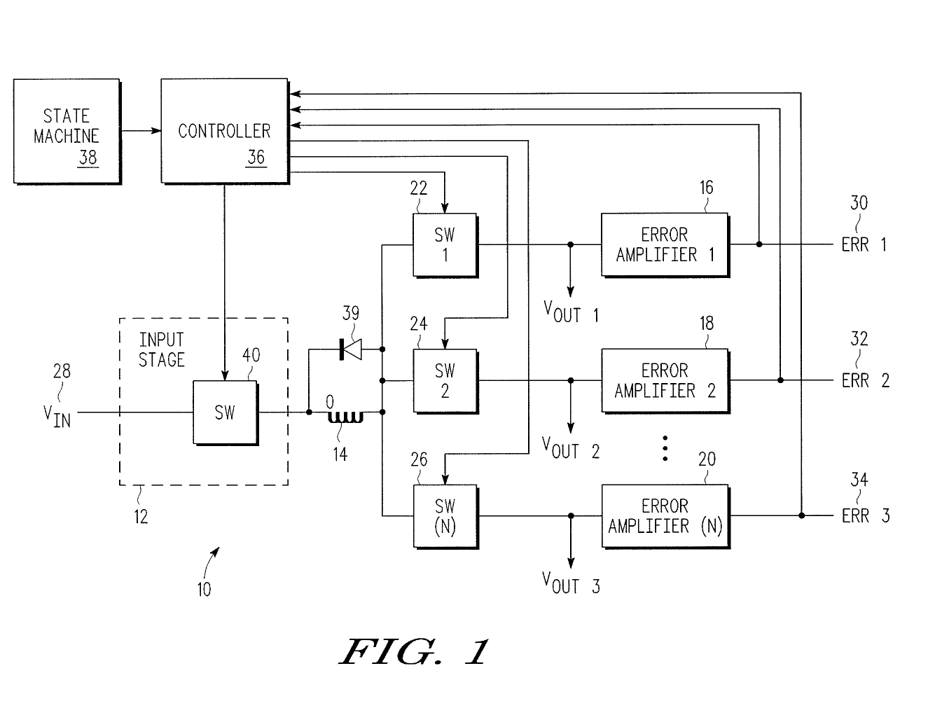

FIG. 1 is a simplified block diagram of an exemplary DC/DC converter configuration 10. As one skilled in the art will anticipate, configuration 10 does not depict each subcomponent which may be implemented in a particular embodiment of a particular DC/DC converter, such as capacitors, voltage supplies, resistors, and the like. For example, various embodiments of DC/DC converters may incorporate additional components to suit a particular application. Additionally, various portions, or the entirety of configuration 10 may be implemented as an integrated circuit.

Configuration 10 as shown includes an input stage portion 12 of the converter, coupled to an inductor coil 14. Coil 14 is coupled to a number of controllable switches (e.g., switches 22, 24, and 26), which are in turn coupled to a number of error amplifiers (e.g., error amplifier circuits 16, 18, and 20) having error signals 30, 32, and 34. The present embodiment depicts three switches, but here as before, any number of independent controllable switches may be realized. The controllable switches are configured so that exactly one is conductive at any time. The switches 22, 24, and 26 may be implemented using such commonly known devices as power field effect transistors (FETs), for example.

An input voltage 28 is processed through the configuration 10 to render a series of output voltages V_{out 1}, V_{out 2}, and V_{out 3}, each of which may be coupled to a load. Again, the output voltages and loads may vary according to application. The output voltages are generally lower than the input voltage to give the most flexibility in control.

Each of the depicted error amplifiers are coupled to a controller 36 via a feedback loop circuit. Additionally, controllable switches 22, 24, 26 are coupled to the controller 36 via control lines. A state machine 38 provides such inputs as sequence logic signals to the controller 36. Controller is also coupled to an input switch 40 which operates to regulate an input current supplied to the inductor 14. The state machine 38, and/or the controller 36 may be implemented using variety of devices known in the art, such as programmable logic devices (PLDs), programmable logic controllers (PLCs), a series of logic gates, flip flops, or relay devices.

A diode 39 is coupled between a terminal of the input switch and the controllable switch network to allow current to flow in the event that all switches 22, 24, and 26 are in the “off” position. Again, various other components may comprise input stage 12, such as resistors, diodes, comparators, ground terminals, and the like, as an input current is processed to input switch 40. Such components are not depicted for ease of illustration.

Configuration 10 is operational as a step down DC/DC converter (“buck” converter). However, with the observance of various constraints, the configuration 10 may be also made operational as a step up DC/DC converter (“boost” converter).

FIG. 2 illustrates an exemplary embodiment of a portion 48 of configuration 10 as illustrated in FIG. 1, including error amplifier circuit 16 with the addition of a connected load 55. Portion 48 includes a variety of components which may be found in the art. Current supplied through the inductor 14 and switch 22 (FIG. 1) reaches node 50. A filter capacitor 52 is coupled between ground 54 and the negative terminal of an error amplifier 56 to reduce output voltage variation. A load 55 is also coupled to node 50, the negative terminal of the amplifier 56, and ground 57 to receive an output voltage.

The positive terminal of the amplifier 56 is coupled through voltage reference signal 58 to ground 60. Similarly, various internal components of the amplifier 56 are coupled to ground 62 (such as an operational amplifier and/or resistors) as one skilled in the art will appreciate. An output terminal of the amplifier 56 is coupled through resistor 64 to an output terminal 66. In one embodiment, resistor 64 may be about 1000 ohms (about 1 kohm). The purpose of resistor 64 is to allow the controller to sum the 3 error amplifier outputs. In addition, the individual error output signals are needed to generate the appropriate duty % as previously described. Accordingly, terminal 66 is coupled to the controller.

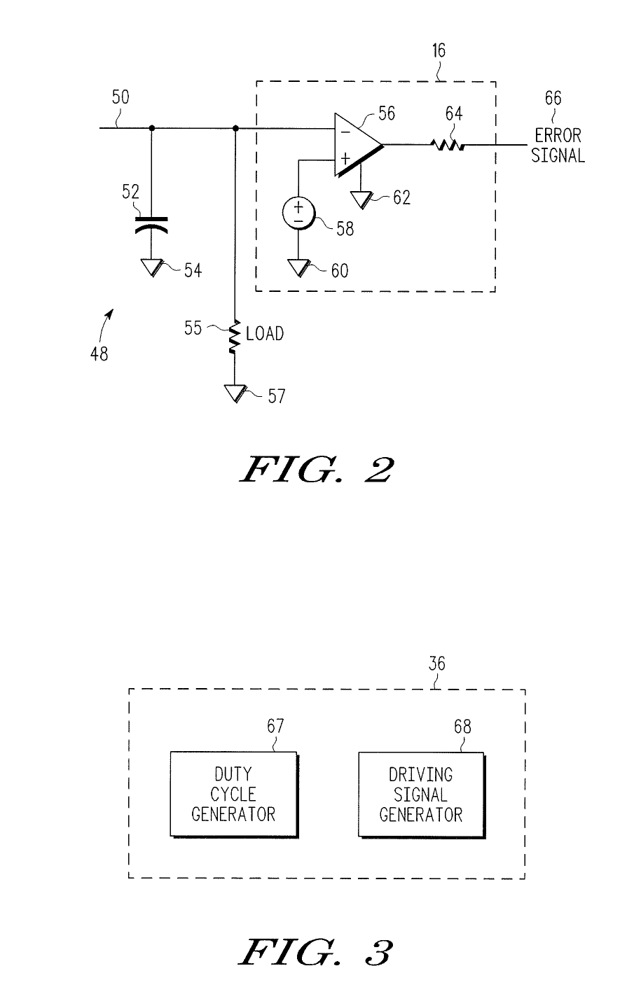

FIG. 3 illustrates a simplified block diagram of exemplary portions of a controller 36 which are relevant to configuration 10 as seen in FIG. 1. Again, however, controller 36 may include additional components, such as additional processors, interfaces, memory devices, and the like as needed for a particular application. In addition, controller 36 or various portions of controller 36 may be integrated with additional electronic components into a single integrated circuit. Along these lines, various discrete components of the converter (including capacitors, resistors, and the like) may be integrated with controller 36 over a single portion of substrate.

By way of example only, controller 36 may include such components as a duty cycle generator 67 which calculates a duty cycle and provides a corresponding control signal to each of the controllable switches 22, 24, and 26 (FIG. 1). Similarly, controller 36 may include a driving signal generator 68 which provides a control signal for the input switch 40 (again, FIG. 1) as appropriate to generate a desired inductor current.

Returning to FIG. 1, when the configuration 10 is in a current control mode (CCM) mode of operation, the error amplifier signals of each output stage are added as E₁+E₂+ . . . +E_{N} to generate a total error signal (current) which is fed back to the controller 36. For example, in a three output converter with amplifiers 1, 2, and 3, if the E₁ is about 1 ampere (A), E₂ is about 2 A, and E₃ is about 3 A, the total output current is 1+2+3=6 A, accordingly. The controller 36 may then set a corresponding inductor or coil current I_{L} as about 6 A, or more generally, according to to I_{L}=I_{L}=kΣEᵢ, where I_{L} is the average inductor current, k is a coil current constant, and ΣEᵢ is the total error signal. The controller 36 actuates the input switch 40 according to the coil current constant to obtain the coil current.

As one skilled in the art will appreciate, such a coil current I_{L} is generally an average coil current, as the switch 40 in input stage 12 is variably actuated to supply a particular current. For example, at a particular moment in time, an instant current through the inductor 14 may be about 6.5 A while the switch 40 is closed. At another particular moment in time, the instant current may be about 5.5 A while the switch 40 is open. The switch 40 may be actuated according to a particular coil switching frequency (e.g., a pulse-width-modulation or PWM frequency) to render the about 6 A of average current.

As a next step, the respective regulator duty cycles (Dᵢ) of each controllable switch 22, 24, and 26 is set by D_{N}=E_{N}/ΣEᵢ, as previously described, where the sum of all duty cycles in the configuration is maintained to be equal to 1. Returning to the example currents, using an average inductor current I_{L} of about 6 A, then the duty cycle of output stage 1 D₁=I₁/I_{L}, or D₁=⅙ or about 0.167. By the same token, D₂= 2/6 or about 0.333, and D₃= 3/6 or about 0.5. Again, as one skilled in the art will appreciate, each of the particular duty cycles can be then applied to the respective operational period of the converter to obtain a time in which each of the respective control switches is “on” (T_{ON}). The T_{ON} may then correspond to a control signal sent by the controller which actuates each of the switches for a certain time. In one embodiment, this period may be a clock cycle, or several clock cycles in another embodiment, again as appropriate. Again, the controllable switches need not switch at the coil switching frequency.

Each load applied to each of the output stages may be independent of another load. By an automatic application of the foregoing equations and configuration 10, which maintains the sum of each of the duty cycles equal to one, the converter may be automatically adjusted to compensate for a change in a load. The respective duty cycles for each of the controllable switches may also be automatically reconfigured. To illustrate, consider the previous example as a preliminary step. The load on output stage 3 then (I_{LOAD3}) changes from about 3 A to about 4 A, demanding a corresponding increase in current through the output stage 3. By again summing the error amplifier currents, the total output current automatically adjusts according to E₁+E₂+E₃, or 1+2+4=7 A, which is then used to set the average inductor current I_{L}. The duty cycle of input switch 40 is then increased to increase the average inductor current I_{L} from about 6 A to about 7 A. As a next step, each of the respective regulator duty cycles for the controllable switches automatically adjusts according to D₁=I₁/I_{L}, or D₁= 1/7 or about 0.143. By the same token, D₂= 2/7 or about 0.286, and D₃= 3/7 or about 0.428. Again, D₁+D₂+D₃=1.

In the previous examples, it is assumed that the order that each successive controllable switch is actuated is in numerical order (i.e., switch 22 turns on and off, followed by switches 24 and 26). This does not necessarily have to be the case, however. The duty cycles for each of the switches 22, 24 and 26 can be reordered over successive cycles to provide enhanced efficiency and performance of the converter. For example, an example series of cycles where switches 22, 24, and 26 are represented as 1, 2, and 3, respectively can proceed as {1, 2, 3}; {3, 1, 2}; {2, 3, 1}; and so on. Controller 36 may be configured to precisely monitor each output stage for current variation. Depending upon the activity of a connected load, the controller may configure the order or reconfigure the order in a particular manner.

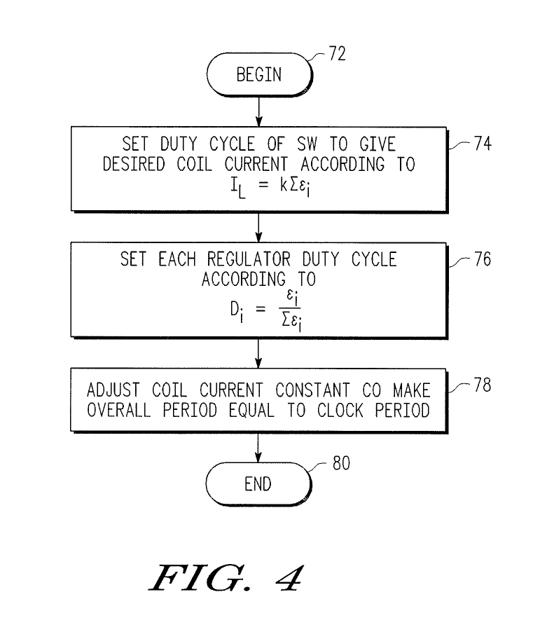

FIG. 4 illustrates an exemplary method 70 of configuring a DC/DC converter incorporating several techniques previously described. Method 70 begins (step 72) by setting the duty cycle of the input switch to give the desired coil current according to I_{L}=kΣEᵢ, k being a coil current constant (step 74). Each of the regulator duty cycles are configured such that Dᵢ=Eᵢ/ΣEᵢ as previously described, where the sum of all duty cycles in the configuration remains equal to 1 (step 76). The coil current constant, implemented by the controller to actuate the input switch and thereby regulate the coil current, may be adjusted to render the overall period of the converter equal to a clock period (step 78). Step 78 may be performed while the DC/DC converter is in operation. Again, in various embodiments, the respective period may be tied to single, or multiple clock cycles. Method 70 then ends (step 80).

In one embodiment, by way of example only, the present description and claimed subject matter describes a method. The method includes summing a plurality of error amplifier signals of a DC/DC converter to obtain a total error signal, using the total error signal to set an average inductor current of the converter, and setting a plurality of duty cycles for a plurality of controllable switches electrically coupled to a plurality of output stages of the converter according to D_{N}=E_{N}/ΣEᵢ, where D_{N} is the duty cycle for an Nth switch of the plurality of controllable switches, E_{N} is an Nth error amplifier signal of the plurality of error amplifier signals, and ΣEᵢ is the total error signal.

In another embodiment, by way of example only, the present description and claimed subject matter describes a DC/DC converter. The converter includes a plurality of error amplifiers. A plurality of controllable switches are electrically coupled to the plurality of error amplifiers. An inductor is coupled to the plurality of controllable switches. An input switch is coupled to the inductor. A controller is coupled to the plurality of controllable switches. The controller is configurable to sum a plurality of received error amplifier signals from the plurality of error amplifiers to obtain a total error signal, set an average inductor current based on the total error signal, and set a plurality of duty cycles for the plurality of controllable switches according to D_{N}=E_{N}/ΣEᵢ, where D_{N} is the duty cycle for an Nth switch of the plurality of controllable switches, E_{N} is an Nth error amplifier signal of the plurality of error amplifier signals, and ΣEᵢ is the total error signal.

In still another embodiment, again by way of example only, the present description and claimed subject matter describes a method of configuring a DC/DC converter having a plurality of outputs for providing a regulated voltage to each output electrically coupled to an error amplifier of a plurality of error amplifiers and an inductor, comprising. The method includes configuring a plurality of controllable switches coupled to the plurality of outputs to operate using a plurality of duty cycles according to D_{N}=E_{N}/ΣEᵢ, where D_{N} is a duty cycle for an Nth switch of the plurality of controllable switches, E_{N} is an Nth error amplifier signal of a plurality of error amplifier signals, and ΣEᵢ is a total error signal generated by summing the plurality of error amplifier signals.

While at least one exemplary embodiment and method of fabrication has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
summing a plurality of error amplifier signals of a DC/DC converter to obtain a total error signal;
using the total error signal to set an average inductor current of the converter;
setting a plurality of duty cycles for a plurality of controllable switches electrically coupled to a plurality of output stages of the converter according to D_{N}=E_{N}/ΣEᵢ, where D_{N} is the duty cycle for an Nth switch of the plurality of controllable switches, E_{N} is an Nth error amplifier signal of the plurality of error amplifier signals, and ΣEᵢ is the total error signal.

2. The method of claim 1, wherein setting the plurality of duty cycles for the plurality of controllable switches is adjusted according to a change in the total error signal of the plurality of error amplifier signals.

3. The method of claim 1, wherein using the total error signal to set an average inductor current further includes providing a control signal via the controller to an input switch regulating an input current to an inductor, the inductor electrically coupled to each switch of the plurality of switches.

4. The method of claim 3, wherein using the total error signal to set an average inductor current further includes actuating the input switch according to I_{L}=I_{L}=kΣEᵢ, where I_{L} is the average inductor current, k is a coil current constant, and ΣEᵢ is the total error signal.

5. The method of claim 1, further including operating the plurality of controllable switches according to the plurality of duty cycles.

6. The method of claim 5, wherein operating the plurality of controllable switches according to the plurality of duty cycles further includes providing a plurality of control signals via the controller to each of the plurality of controllable switches according to a first predetermined order, each of the plurality of control signals corresponding to the each of plurality of duty cycles.

7. The method of claim 6, further including reordering the first predetermined order to obtain a second predetermined order to provide enhanced converter performance.

8. A DC/DC converter, comprising:
a plurality of error amplifiers;
a plurality of controllable switches electrically coupled to the plurality of error amplifiers;
an inductor coupled to the plurality of controllable switches;
an input switch coupled to the inductor; and
a controller, coupled to the plurality of controllable switches, configurable to:
sum a plurality of received error amplifier signals from the plurality of error amplifiers to obtain a total error signal;
set an average inductor current based on the total error signal, and set a plurality of duty cycles for the plurality of controllable switches according to D_{N}=E_{N}/ΣEᵢ, where D_{N} is the duty cycle for an Nth switch of the plurality of controllable switches, E_{N} is an Nth error amplifier signal of the plurality of error amplifier signals, and ΣEᵢ is the total error signal.

9. The converter of claim 8, the controller comprising a driving signal generator coupled to the input switch operable to regulate an input current provided to the inductor.

10. The converter of claim 8, the controller comprising a duty cycle generator coupled to each of the plurality of controllable switches to provide a plurality of control signals to each of the plurality of controllable switches.

11. The converter of claim 10, wherein the duty cycle generator is configured to operate each of the plurality of controllable switches according to a first predetermined order.

12. The converter of claim 11, wherein the duty cycle generator is programmable to reorder the first predetermined order to obtain a second predetermined order to provide enhanced converter performance.

13. The converter of claim 8, wherein the controller is configured to actuate the input switch according to I_{L}=kΣEᵢ, where I_{L} is the average inductor current, k is a coil current constant, and ΣEᵢ is the total error signal.

14. A method of configuring a DC/DC converter having a plurality of outputs for providing a regulated voltage to each output electrically coupled to an error amplifier of a plurality of error amplifiers and an inductor, comprising:
configuring a plurality of controllable switches coupled to the plurality of outputs to operate using a plurality of duty cycles according to D_{N}=E_{N}/ΣEᵢ, where D_{N} is a duty cycle for an Nth switch of the plurality of controllable switches, E_{N} is an Nth error amplifier signal of a plurality of error amplifier signals, and ΣEᵢ is a total error signal generated by summing the plurality of error amplifier signals.

15. The method of claim 14, further including configuring the converter to actuate an input switch coupled to the inductor.

16. The method of claim 15, further including configuring the converter to actuate the input switch to generate an average inductor current according to I_{L}=kΣEᵢ, where I_{L} is the average inductor current, k is a coil current constant, and ΣEᵢ is the total error signal.

17. The method of claim 16, further including configuring the converter to provide a control signal via the controller to the input switch to regulate the input current to the single inductor.

18. The method of claim 14, further including providing a plurality of control signals to each of the plurality of controllable switches according to a first predetermined order, each of the plurality of control signals corresponding to the each of plurality of duty cycles.

19. The method of claim 18, further including reordering the first predetermined order to obtain a second predetermined order to provide enhanced converter performance.

20. The method of claim 14, further including adjusting the average inductor current to equate an overall period of the converter with a clock period of the controller.
